(19) United States
(12) Patent Application Publication
(10) Pub. No.: US 2025/0202307 A1
(43) Pub. Date: Jun. 19, 2025

(54) Line Element Having Efficiently Producible Insulation

(71) Applicants: Siemens Aktiengesellschaft, München (DE); Siemens Mobility GmbH, München (DE)

(72) Inventors: Steffen Lang, Hallerndorf (DE); Florian Schemmel, Nürnberg (DE); Marek Maleika, Fürth (DE); Niels Müller, Georgensgmünd (DE)

(73) Assignees: Siemens Aktiengesellschaft, München (DE); Siemens Mobility GmbH, München (DE)

(21) Appl. No.: 18/849,945

(22) PCT Filed: Mar. 16, 2023
(86) PCT No.: PCT/EP2023/056776

§ 371 Date: Sep. 23, 2024

(30) Foreign Application Priority Data
Mar. 24, 2022 (DE) 10 2022 202 880.5

(51) Int. Cl. H02K 3/40; H02K 3/38; H02K 15/10

(52) U.S. Cl. CPC H02K 3/40; H02K 3/38; H02K 15/10

(57) ABSTRACT

Various embodiments of the teachings herein include a conductor element of an electrical rotating machine. An example includes: a conductive core having a voltage rating greater than 700 volts; and a powder coating insulating the conductive core. The powder coating comprises two uncrosslinked plastics components comprising a solid at room temperature under standard conditions. A first uncrosslinked polyimide-containing plastics component and a second uncrosslinked epoxy-containing plastics component are present in the powder coating in a mixing ratio between 99:1 and 1:99.

### CROSS-REFERENCE TO RELATED APPLICATIONS

This application is a U.S. National Stage Application of International Application No. PCT/EP2023/056776 filed Mar. 16, 2023, which designates the United States of America, and claims priority to DE Application No. 10 2022 202 880.5 filed Mar. 24, 2022, the contents of which are hereby incorporated by reference in their entirety.

### TECHNICAL FIELD

The present disclosure relates to electric machines. Various embodiments of the teachings herein include conductor elements such as a winding head and/or a copper flat wire of an electrical rotating machine, in particular of an electric motor, traction motor and/or generator, having efficiently producible insulation.

### BACKGROUND

Electrical rotating machines in the medium- and high-voltage range such as electric motors and electric generators are characterized by a multitude of different designs and fields of application. They are used in all areas of technology, industry, everyday life, transportation, medicine and other fields. The power range of electrical machines spans from orders of magnitude below a microwatt, for example in microsystem technology through to above a gigawatt, i.e. one thousand times one million watts, for example in the power plant sector. Between these lie medium-voltage applications comprising traction and drive motors in the vehicle sector, rail vehicle sector, etc.

Common to all rotating electrical machines are conductor elements such as winding head, copper flat wire in hairpin technology and/or wire coils which conduct electrical current. To effect electrical insulation of the current-conducting conductor elements from one another and from the external environment electrical machines comprise insulation systems.

Electrical rotating machines, for example electric motors and generators above a rated voltage of 700 V comprise a rotor surrounded by the stator. The stator has a laminated stack comprising grooves in which the electrical conductor elements are inserted in the form of coils or as individual rods that are welded or soldered to form coils. Two corresponding individual rods can be welded together to form a respective coil. The electrical subconductors are insulated from one another in the coil, the coil is additionally provided with a main insulation made of mica-containing insulating tapes and finally, optionally depending on the voltage level, also provided with a conductive corona shield, in particular an outer and/or terminal corona shield, so that the surface of the coil has the same potential as the laminated stack. This construction is also known as an “ordered” winding in contrast to the electrical rotating machines with wires in a “random” winding which generally concern electrical rotating machines having a rated voltage of less than 700 V.

Electrical rotating machines in the high- and/or medium-voltage range comprise coils composed of subconductors insulated from one another for example through wrapping and/or wire lacquer. These are formed from blanks, such as a coil loop, by drawing and twisting, such that they can be inserted into the grooves of a main stator body, i.e. into the laminated stack of the electric motor. The coils are connected to one another via so-called winding heads and contacted by corresponding terminals.

The current-conducting coils are insulated from one another, from the laminated stack and ultimately also from the environment by an insulation system. The insulation system regularly comprises the main insulation, which is a pure insulator, and the corona shield system which comprises the components outer corona shield and/or terminal corona shield, wherein a corona shield system also exhibits a small electrical conductivity for improved partial discharge resistance.

The current-conducting coil is largely insulated from the grounded laminated stack by the main insulation composed of polymer-based materials. To extract maximum power from the machine it is operated at the highest possible current densities, though this also results in appreciable losses in the form of heat. In the case of large electric motors the maximum customary operating temperature is about 155° C. For these operating temperatures it is known to employ an insulation system composed of mica tape and epoxy-based thermosetting plastics. The motor is configured such that the maximum heating—also of the insulation—does not exceed or not substantially exceed 155° C.

To increase the power density of such a machine either the voltage or the current is increased. Were the voltage to be increased, it would be necessary to permanently dissipate a higher field strength over the insulation system. The conventionally known epoxy-based insulation systems are not configured for this. If the current is increased the insulation system is subjected to greater thermal stress, even to over 200° C. at least for short periods. To this end insulation systems comprising materials based on m-aramid and polyether imide are employed.

Hitherto, all components of an insulation system, i.e. the main insulation and the corona shield, such as especially the outer corona shield AGS and the terminal corona shield EGS, are generally wrapped onto the subconductors as tapes, wherein parts thereof, such as the EGS, may also be applied by hand. The other parts also cannot be applied in fully automated fashion, either because the production volume does not lend itself to economic automation and/or the risk of air inclusions in the folds of the wrapping tapes does not ensure the quality required in the wrapping. The tapes that are wrapped usually comprise bonded mica flakes which serve in the insulation to extend the erosion path in the insulation system, i.e. the direct path from the voltage side, the conductor elements, to the earthed laminated stack, thus resulting in a markedly longer service life of an insulation system.

Especially for traction motors and industrial motors, the winding head is insulated with the same insulation tape as is used in the groove of the active part. In the hitherto customary impregnation process the winding head is thus impregnated with the same wrapping tape and impregnation resin and subsequently cured in the same way as the active part. The winding of the winding head is time-intensive and thus also cost-intensive. The hitherto required impregnation process with impregnation resin is likewise time- and cost-intensive.

The field strengths present in the winding head in operation are many times lower than in the active part and are smaller than 500 V/mm in the wrapped insulation itself. Partial discharges typically cannot occur there during operation. The winding head is nevertheless insulated in the same way as the active part in the prior art because separating the production of insulation between the active part and the winding head would be still much more complex and costly. A winding head insulation especially safeguards the dielectric barrier and prevents phase flashover and/or a ground short in the event of contamination. Accordingly, the winding head insulation does not require enhanced resistance to partial discharges but in principle has a certain minimum dielectric strength. This especially applies in traction machines having an insulation temperature resistance of greater than 200° C., corresponding to heat class 200.

### SUMMARY

Teachings of the present disclosure include winding head insulation which firstly is applicable in automated fashion and secondly remains stable even at operating temperatures above 155° C., in particular also at up to 200° C. or 220° C., shows the required dielectric strength and thus functions as a dielectric barrier at the winding head and prevents phase flashover and/or a ground short in the event of contamination. For example, some embodiments include a conductor element of an electrical rotating machine having a rated voltage greater than 700 volts having a powder coating as insulation, wherein the employed powder coating formulation comprises at least two uncrosslinked plastics components that are solid at room temperature—RT—under standard conditions, i.e. at about 20° C., at least one first uncrosslinked polyimide-containing plastics component and a second uncrosslinked epoxy-containing plastics component which are present in the powder coating formulation in a mixing ratio of 99:1 to 1:99.

In some embodiments, the first uncrosslinked polyimide-containing component of the powder coating formulation comprises a bismaleic polyimide.

In some embodiments, the first uncrosslinked polyimide-containing plastics component of the powder coating formulation contains a mixture, a copolymer and/or a blend comprising two or more polyimide-containing plastics components.

In some embodiments, the second uncrosslinked epoxy-containing plastics component of the powder coating formulation comprises one or more solid epoxy resins.

In some embodiments, the second uncrosslinked epoxy-containing plastics component of the powder coating formulation contains a mixture, a copolymer and/or a blend comprising two or more epoxy-containing plastics components.

In some embodiments, the two uncrosslinked plastics components in the powder coating formulation are in the form of a mixture, blend or copolymer.

In some embodiments, the powder coating formulation contains fillers.

In some embodiments, the powder coating formulation contains additives.

As another example, some embodiments include a process for producing an insulation of a conductor element comprising: providing a thermosetting powder coating formulation comprising at least two uncrosslinked plastics components, wherein at least one first uncrosslinked polyimide-containing plastics component and at least one second uncrosslinked epoxy-containing plastics component are present in the powder coating formulation and are each present as a solid at room temperature under standard conditions, i.e. at about 20° C., single or repeated powder coating of the conductor element and subsequent curing and/or post-curing of the resulting powder coating.

In some embodiments, the process is performed in automated fashion.

In some embodiments, the conductor element is a winding head.

In some embodiments, the conductor element is a copper flat wire.

As another example, some embodiments include an electrical rotating machine having a rated voltage greater than 700 volts, wherein the material of the active part insulation is dissimilar to the material of the winding head insulation.

In some embodiments, the material of the active part insulation is siloxane-containing and the material of the winding head insulation is not.

In some embodiments, the insulation of the winding head is mica tape-free.

As another example, some embodiments include an electrical rotating machine in hairpin technology, wherein the active part insulation is producible by injection molding and the winding head insulation is producible by powder coating as described herein.

### DETAILED DESCRIPTION

Various embodiments of the teachings herein include a conductor element such as a winding head and/or a copper flat wire of an electrical rotating machine having a rated voltage greater than 700 volts with powder coating insulation, wherein the powder coating formulation for producing the powder coating insulation comprises at least two uncrosslinked plastics components that are solid at room temperature-RT-under standard conditions, i.e. at about 20° C., at least one first uncrosslinked polyimide-containing plastics component, in particular a bismaleimide plastics component, and a second uncrosslinked epoxy-containing plastics component which are present in the powder coating formulation in a mixing ratio of 99:1 to 1:99.

Some embodiments include a process for producing an insulation of a conductor element, such as a winding head and/or a copper flat wire, comprising:
providing a thermosetting powder coating formulation comprising at least two uncrosslinked plastics components, wherein at least one first uncrosslinked polyimide-containing plastics component, in particular a bismaleimide plastics component, and at least one second uncrosslinked epoxy-containing plastics component are present in the powder coating formulation and are each present as a solid at room temperature under standard conditions, i.e. at about 20° C.;
single or repeated powder coating of a winding head and subsequent; and
curing and/or post-curing of the resulting powder coating.

Some embodiments include an electrical rotating machine having a rated voltage greater than 700 volts where the insulation of the active part is dissimilar in terms of its material from the insulation of the winding head.

Especially in hairpin technology, which is a modern winding technology for stators in electrical machines, novel methods are being trialed as a replacement for mica tape insulation in the active part. For example, instead of the winding technology where the conductor elements are wound into the groove, a copper flat wire having a typical hairpin geometry is in this case introduced into the grooves of the laminated stack in a forming-based assembly process. This makes it possible to insulate the coil sides provided for the active part which are part of the hairpin geometry for example by injection molding with partial discharge-resistant, especially also siloxane-containing, material and then to provide the winding head produced after the insertion into the grooves with an insulation which is dielectric but less partial discharge-resistant, if at all. The teachings of the present disclosure provide a winding head insulation which is uncomplicated to apply and exhibits the required dielectric strength but does not employ the costly resins for the partial discharge-resistant insulations of the active part. Powder coating with a thermosetting powder coating formulation makes it possible to produce the insulation of a conductor element such as the winding head insulation and/or the insulation of a copper flat wire rapidly and in automated fashion, for example using corona and/or tribo and/or fluidized bed processes.

In some embodiments, one or both winding heads of electrically rotating machines, motors and generators are insulated with a thermosetting powder coat by powder coating. Said coating is applied for example using corona and/or tribo and/or fluidized bed processes in automated fashion.

For the insulation of the active part of the electrically rotating machine the subconductors of the coils are initially coated with a subconductor insulation. The subconductor insulation may be a wire lacquer or a wrapped insulation. Then the drawn coil, for example the wound or hairpin-geometry or else undrawn coil is insulated in the active part in some fashion, for example by individual coil manufacture and/or by injection molding of the active part and/or by powder coating. Then all coils are inserted and respectively bonded into the groove for example with a kit or a groove adhesive and connected to one another. In an advantageous embodiment of the process an insulation is then produced at the winding head including connections by powder coating.

This results for example in an electrical rotating machine in hairpin technology where in one exemplary embodiment of the invention the active part insulation is producible by injection molding and the winding head insulation is producible by powder coating.

The provision of the uncrosslinked powder coating formulation is achieved simply by weighing and mixing, wherein the powder coating is incipiently melted, degassed and/or incipiently crosslinked on the substrate, the coil or the coil part. After the powder coating and once a solid film has been obtained, post-curing and curing are effected at elevated temperature.

A distinction is made between 2 types of powder coatings, firstly
electrostatic powder coating which functions either via corona methods, i.e. charging via a generator, or via the so-called “tribo” method with triboelectric charging and secondly the
fluidized bed sintering method, also known as “powder slurry” in the automotive sector.

In electrostatic powder coating, the powder coating formulation is sprayed onto an electrically conductive workpiece. A so-called spray unit, i.e., for example, the spray gun, is used to shape the swirling powder into a defined spray jet and simultaneously electrostatically charge it, with different charging methods being possible for the method employable here.

In corona spray systems, the powder particles of the powder coating formulation are charged by additions of free air ions that are generated by means of one or more voltage-conducting corona electrodes in the spray unit. In general, a negative voltage is chosen because the corona has higher current and is more stable, and back-spraying effects at the workpiece surface occur to a reduced extent. A voltage of up to 100 kV is applied at the corona electrode.

In the case of “tribo” spray systems, the powder particles of the powder coating formulation are charged exclusively via triboelectric processes as they flow through a plastic channel in the spray unit, i.e., for example, in the spray gun, i.e. without voltage generators. This positively charges the powder particles.

The spray application is followed by curing and/or baking, wherein the powder coating may contain all the constituents of a normal wet lacquer except for the solvent and hence-depending on the polymer component composition-melts to give a continuous film at relatively high temperatures, for example above 100° C., especially above 120° C., and then partly gelates and cures.

Compared to wet painting operations, there are may be a number of advantages in terms of cost and/or for the environment in powder coating:
solvent-free coating material and minimal emission,
recirculation of the powder coating possible,
simple manual handling of a spray gun or some other spray unit and
suitable for automation.

In some embodiments, powder coating can also be performed by a fluidized bed sintering method. This involves providing a powder bath from moving air, especially an air stream, and the fluidized powder coating formulation, and dipping a heated substrate into said powder bath—for example even for just a few seconds. On contact with the hot substrate, the powder starts to sinter and melts and/or subsequently crosslinks to give a smooth polymer layer. For example, in the production of the insulation system, final insulation of the winding heads can be effected by fluidized bed sintering at about 200° C.

In some embodiments, the powder coating formulation contains one or more first polyimide-containing polymer component(s) and one or more second epoxy-containing polymer component(s). “Polyimide” in the solid but uncrosslinked powder coating refers to a monomer or oligomer of a polymer having a “polyimide group”. This generally denotes a compound having a unit as shown in structural formula I:

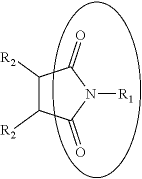

I. The polyimide group is circled.

R2 may be identical or different to R3 and represent any desired organic molecular unit which is sterically possible on a C5 five-membered ring.

In some embodiments, the polyimide component employed is in particular a bismaleic polyimide because
a) said polyimide is readily processable as a powder coating constituent in combination with the epoxidic component and
b) bismaleimide, in particular the species of this compound class shown below, cures to afford a polyimide having the required dielectric strength.

Some bismaleimides used are those conforming to the following structural formulae:

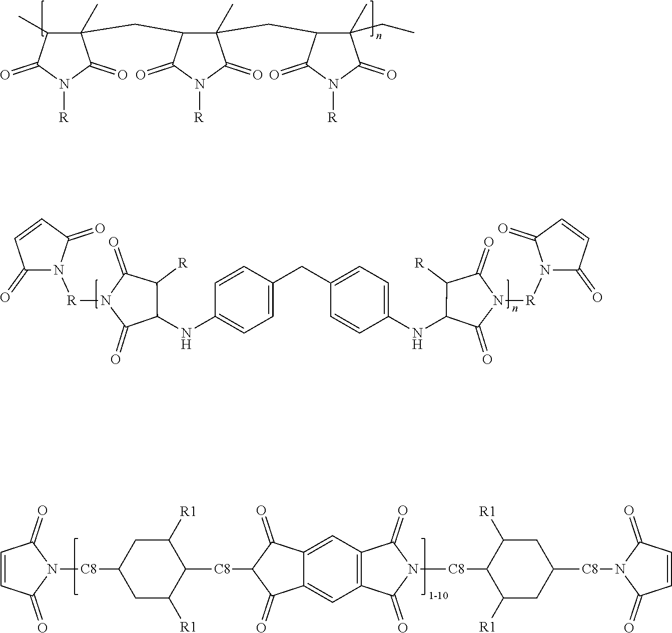

The uncrosslinked polyimide is also mixed with an uncrosslinked epoxy-containing solid plastics component which is present in the powder coating formulation in a mixing ratio of 99:1 to 1:99. The mixing with a solid epoxy-containing plastics component also ensures, among other things, that the mechanical properties and the flow properties of the powder coating formulation in the coating process are improved.

The terms “epoxy resin” or “epoxy-containing uncrosslinked plastics component” are to be understood as referring to any synthetic resin bearing an epoxy group.

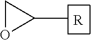

R may be any desired carbon-based molecular structure. R may also comprise further epoxy groups, in particular terminal epoxy groups, suitable for crosslinking.

In some embodiments, the thermosetting powder coating formulation may further contain one or more further binders including thermoplastic binders in addition to the two uncrosslinked polyimide-containing and epoxy-containing plastics components that are present as solids.

In the applied powder coating formulation, the two plastics components are incipiently melted through application of heat, for example in the form of convective and/or radiative energy, and then cured in a crosslinking reaction.

In some embodiments, the powder coating formulation is applied in such a way as to result in a thickness of the insulation layer and/or corona shielding layer formed therefrom of >/=100 μm. This layer may be produced in single-layer or multilayer form by powder coating.

In some embodiments, the formulation further comprises fillers, especially sphere-shaped and/or irregular-shaped fillers. The fillers may be crystalline and/or amorphous.

In some embodiments, the fillers are based on silicon dioxide and for example contain fused silica, ground quartz and/or quartz glass.

The dielectric strength of the sprayable powder coating formulation may be increased by adding fillers, especially mineral or/and synthetic fillers, such as ground quartz, fused silica, ground glass, in a proportion by mass of, for example, 5% by weight to 65% by weight, in particular of 10% by weight to 60% by weight and especially advantageously of 10% by weight to 55% by weight.

In some embodiments, it is possible to eschew the use of tape-bonded large mica flakes and to apply and produce the winding head insulation in the form of a powder coating formulation in automated fashion by spraying and/or immersion.

The powder coatings described herein may be exceptionally suitable for performing in automated fashion despite a high dielectric strength without mica particles.

In some embodiments, the powder coating formulation which is in the form of a powder of solids at room temperature also comprises fillers, especially in two or more fractions, and sintering aids and/or additives.

In some embodiments, the powder coating formulation may contain one or more additives. For example, additives for improving processability may be present.

In some embodiments, additives for increasing the stability of the insulation system may be present. For example, one or more metal oxide(s), for example TiO₂ and/or those with one of the following empirical formulae Na₈Al₆Si₆O₂₄S₄ and/or Na₆Al₆Si₆O₂₄S₂ are possible. Further additives may be Fe₂O₃ and/or MnFe₂O₄ and/or electrically nonconductive carbon-based fillers, for example industrial carbon black. If required, the additive particles may be provided partly or wholly, over the full area or part of the area, with an SiO₂ coating. These additives may also be oxidation-inhibiting, such that the heat class or temperature index of a powder coating produced therewith can be increased further.

Additives are admixed in the production of the powder coating formulation for example. Further additives, flow auxiliaries, color pigments, quartz particles and the like may be admixed with the powder coating formulation. The proportion of additive in the powder coating is, for example, in the range between 0.05% and 10% by weight, especially in the range between 0.05% and 2% by weight and more preferably in the range between 0.1% and 1% by weight.

The powder coatings described herein to produce the insulation of a conductor element of an electrical rotating machine with a rated voltage greater than 700 volts makes it possible to avoid the costly and complex VPI process which has hitherto been predominantly used for insulation of the active part and the winding head. It is thus possible to eschew the conventional mica tapes and to effect automated insulation of the active part and the winding head with insulation material appropriate in each case. Especially the insulating of the winding head may be achieved markedly more rapidly and more cost-effectively than compared to the prior art. In addition, the degree of automation in the production of an electrical rotating machine is markedly higher.

What is claimed is:

1. A conductor element of an electrical rotating machine, the conductor element comprising:
a conductive core having a voltage rating greater than 700 volts; and
a powder coating insulating the conductive core;
wherein the powder coating comprises two uncrosslinked plastics components comprising a solid at room temperature under standard conditions;
wherein a first uncrosslinked polyimide-containing plastics component and a second uncrosslinked epoxy-containing plastics component which are present in the powder coating in a mixing ratio ween 99:1 and 1:99.

2. The conductor element as claimed in claim 1, wherein the first uncrosslinked polyimide-containing component comprises a bismaleic polyimide.

3. The conductor element as claimed in claim 1, wherein the first uncrosslinked polyimide-containing plastics component comprises: a mixture, a copolymer, and/or a blend of two or more polyimide-containing plastics components.

4. The conductor element as claimed in claim 1, wherein the second uncrosslinked epoxy-containing plastics component comprises one or more solid epoxy resins.

5. The conductor element as claimed in claim 1, wherein the second uncrosslinked epoxy-containing plastics component comprises a mixture, a copolymer and/or a blend comprising two or more epoxy-containing plastics components.

6. The conductor element as claimed in claim 1, wherein the two uncrosslinked plastics components in the powder coating formulation each comprise a mixture, a blend, or a copolymer.

7. The conductor element as claimed in claim 1, wherein the powder coating comprises fillers.

8. The conductor element as claimed in claim 1, wherein the powder coating comprises additives.

9. A process for producing an insulation of a conductor element, the process comprising:
coating a conductive core with a thermosetting powder coating formulation;
wherein the powder coating formulation includes two uncrosslinked plastics components;
wherein a first uncrosslinked polyimide-containing plastics component and a second uncrosslinked epoxy-containing plastics component are each present as a solid at room temperature under standard conditions;
curing the powder coating on the conductive core; and
coating the coated conductive core with the powder coating formulation one or more additional times.

10. The process as claimed in claim 9 performed in automated fashion.

11. The process as claimed in claim 9, wherein the conductor element comprises a winding head.

12. The process as claimed in claim 9, wherein the conductive core comprises a copper flat wire.

13. An electrical rotating machine having a rated voltage greater than 700 volts, the machine comprising:
a plurality of conductor elements;
insulation isolating the conductor elements from one another at least in part;
a first insulation for an active part of the machine; and
a second insulation for a winding head;
wherein the material of the first insulation is dissimilar from the material of the second insulation.

14. The electrical rotating machine as claimed in claim 13, wherein the material of the first insulation comprises siloxane and the material of the second insulation comprises no siloxane.

15. The electrical rotating machine as claimed in claim 13, wherein the second insulation comprises no mica tape.

16. (canceled)
